(19) United States
(12) Patent Application Publication
(10) Pub. No.: US 2015/0088603 A1
(43) Pub. Date: Mar. 26, 2015

(54) USER-CONTROLLED IDENTITY PROFILES

(71) Applicants: Steve Romero, Portland, OR (US); Roy Leon Camp, Cupertino, CA (US)

(72) Inventors: Steve Romero, Portland, OR (US); Roy Leon Camp, Cupertino, CA (US)

(73) Assignee: EBAY INC., SAN JOSE, CA (US)

(21) Appl. No.: 14/192,722

(22) Filed: Feb. 27, 2014

Related U.S. Application Data
(60) Provisional application No. 61/882,114, filed on Sep. 25, 2013.

(51) Int. Cl. G06Q 30/02

(52) U.S. Cl. CPC G06Q 30/0201
USPC 705/7.29

(57) ABSTRACT

In an example embodiment, an identity system comprises a data repository for storing user-controlled personal data; an enrollment module to enroll users with the data repository; a first communication module to receive an enrolled user authentication and personal data relating to the user; a control module allowing an authenticated user to supplement or modify the received personal data and to select recipients of user-identified aspects of the received personal data; and a second communication module to communicate the user-identified aspects to a selected recipient. A payment module may be configured to convey a value to the user based on the communication to, or use by, the selected recipient of the user-identified aspects of the personal data.

### CLAIM OF PRIORITY

This patent application claims the benefit of priority, under 35 U.S.C. Section 119(e), to Romero et al, U.S. Provisional Patent Application Ser. No. 61/882,114, entitled “User-Controlled Identity Profiles,” filed on Sep. 25, 2013, which is incorporated by reference herein in its entirety.

### TECHNICAL FIELD

The subject matter disclosed herein generally relates to user-controlled identity profiles in an electronic identity system. Specifically, in one example, the present disclosure includes an identity system having a data repository for maintaining user-controlled marketing profiles for multiple users and merchants.

### BACKGROUND

In the networked world of today, content providers and ecommerce merchants increasingly seek to target customers with user-relevant information or advertisements. Some users are becoming increasingly concerned that confidential aspects of their identity or online behavior are being mined and used without permission, or at least without the user's knowledge. Although marketing profiles of users are bought and sold frequently in the enterprise marketing world, users are often not empowered to have much control over this activity, if at all. In some instances, the collection of detailed personal data is seen as being particularly intrusive and may occur in a manner in which the user has no control on the extent or way in which the information is gathered or used. Interest groups and some governmental authorities have become increasingly vocal about user's rights in this regard.

There is also a danger that the blind collection of online data leads to incorrect or misleading user profiles being assembled. For example, a grandson regularly buying incontinence products online for his grandmother may incorrectly be identified and targeted variously as being a female, an old-age pensioner, or incontinent. There is a reasonable chance that by using conventional targeting techniques the grandson will be presented with all sorts of advertisements and offerings that have little to do with his true preferences or personal situation. The excessive transmission of irrelevant information can clog internet bandwidth and serves neither the user nor those entities intending to offer in good faith user-relevant products or services.

Receipt of unsolicited irrelevant information can cause great annoyance and, in fact, be counterproductive to generating brand goodwill. Equally, aspects of online identity, such as erroneous or unofficial credit scores, may be particularly hard to correct. It will be appreciated that many other examples of misidentification and misuse of personal data are possible.

### SUMMARY

The present inventors seek to address the problems discussed above. The inventors recognize, among other things, that problems to be solved can include the intrusive or undetected collection of personal information and the potential misuse of such information. The present subject matter can help provide a solution to these problems, such as by providing a user-controlled identity system. The system allows users to control the collection of, access to, and use of their personal information. In some examples, this information may be stored safely in one or more controlled repositories maintained by a repository controller.

In an example embodiment, an identity system comprises a data repository for storing user-controlled personal data; an enrollment module to enroll users with the data repository; a first communication module to receive an enrolled user authentication and personal data relating to the user; a control module allowing an authenticated user to supplement or modify the received personal data and to select recipients of user-identified aspects of the received personal data; and a second communication module to communicate the user-identified aspects to a selected recipient.

The identity system may further comprise a payment module to convey a value to the user based on the communication to, or use by, the selected recipient of the user-identified aspects of the personal data. In some examples, the control module is further to allow the user to select or restrict targeted information from the selected recipient. In some examples, identity system further comprises an anonymizer module to associate an opaque identifier with the user-identified aspects of the personal data. The second communication module may be to communicate the opaque identifier and user-identified aspects of the personal data to the selected recipient without identifying the user. In some examples, the identity system further comprises a subscription module for allowing a third party to register with the data repository as a potential recipient of the user-identified aspects of the personal data.

In another example embodiment, a non-transitory machine-readable storage medium comprises instructions that, when executed by one or more processors of a machine, cause the machine to perform operations including maintaining a data repository for storing user-controlled personal data; enrolling, using a processor of a machine, users with the data repository; receiving, using a processor of a machine, an enrolled user authentication and personal data relating to the user; allowing an authenticated user to supplement or modify the received personal data and to select recipients of user-identified aspects of the received personal data; and communicating the user-identified aspects to a selected recipient.

These and other examples and features of the present identity system, related methods, and machine-readable media will be set forth in part in the following Detailed Description. This Summary is intended to provide non-limiting examples of the present disclosure. It is not intended to provide an exclusive or exhaustive explanation. The Detailed Description below is included to provide further information about the present disclosure.

### BRIEF DESCRIPTION OF THE DRAWINGS

Some embodiments are illustrated by way of example and not limitation in the figures of the accompanying drawings.

FIG. 1 illustrates a data flow diagram showing the transfer of information between a user, a user-controlled data repository, and a recipient, accordance with a general example embodiment.

FIG. 2 is a block diagram illustrating an example of a network environment for implementing particular disclosed embodiments.

FIG. 3 is a block diagram illustrating components of an identity system including a machine for implementing particular disclosed embodiments.

FIG. 4 is a block diagram illustrating data relationships in an example disclosed embodiment.

FIG. 5 is a flowchart illustrating operations of a device in performing particular disclosed embodiments.

FIG. 6 is a block diagram illustrating an example computer system architecture.

### DETAILED DESCRIPTION

Disclosed in some examples are systems, methods, and machine-readable media which relate to user-controlled identity profiles in an electronic identity system. In one aspect, an identity system includes a personal data repository. The system allows a controller of the personal data repository to collect, derive, curate, maintain, and/or generate marketing profiles for users. The profiles may be highly detailed based on information submitted by users enrolled in the system, or collected with the users' consent. The personal data may include, but is not limited, to age, gender, schooling, financial information, “likes,” interests, owned items, wants/needs, online behavior, and so forth. The personal data may also include, or be derived from, segmentation and classification of data with respect to other users, or users in a similar class. The collection of class data or segmentation can help fill in gaps of information that may be missing in relation to a specific user, or to smaller classes of user. It will be appreciated that many other aspects of personal data are possible, and in some examples these can all be stored under a user's control in a data repository. The stored information may selectively be revealed or released with the user's permission to recipients (discussed below) who are able to use the data to present targeted, relevant information to users. In an important aspect of this disclosure, the personal information is collected, transmitted, and/or used under the control of users enrolled with the identity system.

In some examples, the data repository of the identity system is managed by a repository controller. The controller may allow users to authorize release of their personal data to third parties, such as merchants, online content providers, or brand Facebook sites, for example. In return, users authorizing release may, in return for release, receive value, such as monetary compensation, coupons, highly targeted advertisements or notifications, a customized store experience, or other items or services of value. The value received may, in some examples, be dependent on the extent to which data is submitted or stored in the repository, or the extent to which it is used by a recipient.

A user's controlled identity in the repository may include personal data or user profile information. In this specification, these terms are used interchangeably and inclusively. The personal data in the repository may be collected by the controller, or deposited in the repository by enrolled users. The controller or user may submit or amend the data using secure access via an online portal, for example. In some examples, a user's profile (personal data) may be maintained by the controller based on updates submitted by a user. The controller may provide regular profile updates to recipients (such as marketing entities, content providers, and so forth) about which a user has expressed an interest in being further informed, for example.

In some examples, users may have the ability to revoke or remove their data from a recipient, or even from the repository itself. In some examples, the user may be able to update or remove aspects of the stored personal data, or may in some examples be unable to remove or delete certain data, such as data relating to prior criminal convictions, social security numbers, or prior bad debts, for example. Other examples of such data are possible.

In broad overview, a user thus “owns” his or her identity in the repository, controls how his or her personal information is gathered or stored, and may selectively control to whom the information is sent, or from whom targeted information is received.

In some examples, access to the personal data of a user may be provided by the repository controller to a third party, such as an online or “real-world” merchant, using an Application Programming Interface (API) facility. In some examples, the API facility may be disabled on demand for a specific user intending to remove access by third parties to his or her personal data. Users may also have very detailed control or authority over what types of data are to be stored or shared by the repository, and to whom this data is transmitted or revealed. A user may also control whether his or her personal data is to be collected or shared in an anonymous or identifying manner. A default condition of the identity system or data repository may be to maintain the anonymity of users.

In this regard, anonymous identifiers may be used to tag personal data without revealing the identity of the associated user. In some examples, “opaque” data strings may be randomly generated to accompany or segregate user profile data stored, accessed, or sent to third parties. The opaque data strings do not identify any user, but may be associated with user profile data. The user profile data may be aggregated in sonic examples. The data strings may be used to expedite data entry into web pages, in data processing, or in the compilation of targeted information, for example. It will be appreciated that other association techniques or devices may be used in order to maintain the confidentiality or anonymity of users and/or their personal data in the repository.

In some examples, the repository is self-healing in the event of data breach. For example, an original set of opaque data strings associated with corresponding user profiles may be deactivated and replaced with new opaque data strings in the event of breach or misuse of repository information. The deactivation and replacement of data strings may occur regularly in any event in order to refresh security aspects of the repository and frustrate hackers seeking to gain unauthorized access to the repository. In some examples, specific user biometric data (facial recognition, fingerprints, and so forth) may be required to gain access to the repository.

In some examples, the repository may be hosted and maintained by a governmental or national authority. In other examples, the repository may be hosted by private parties. The repository may be centralized or hosted in separate locations.

In some examples, data recipients, such as marketing entities, targeted delivery services, or content providers, may subscribe to the repository to be granted access to user-controlled profiles or personal data. Such access may be limited, indefinite, or granted for one-time use only. A user may require the repository to be accessed each time a user's profile or personal data is used or sent to a third party. The user may further require a recipient or the repository to destroy personal data or profile once used. Generally, a user has the ability to limit the time or extent to which any personal data is used. In some examples, check boxes may be provided allowing a user to select or restrict notifications from subscribed recipients.

While on the one hand the identity system affords a high degree of identity control to a user, the information stored in the repository is, on the other hand, of significantly increased value to recipients, particularly marketing entities, targeted delivery services, merchants, content providers, and the like. The repository data allows such parties to provide enhanced engagement opportunities with users based on the specific (and authorized) personal data or user profile information that the user controls. More fruitful engagement opportunities, such as time of day, spending budgets, and so forth, may be identified based on preferences or aspects of personal information identified by users enrolled in the system, a recipient, or by the repository controller, for example. Relevant and richer data may be exchanged to the benefit of both user and recipient. Merchants and online content providers, for example, can focus on selected clients or consumer segments without having to resort to batch emailing techniques, data dumps, or analyzing sparse or imprecise click-through rates, for example. Frustration and screen clutter generated by unsolicited notifications or advertisements can be minimized. In appropriate applications, brand equity or awareness can be enhanced while meeting the requirements of consumer privacy laws.

In other applications of the identity system, health information may be submitted voluntarily by users for storage in the repository. Consider a user suffering from a disease or disability. The user may be very interested in a cure and may even further be prepared to participate in medical research to find a cure for his or her disease. To this end, the repository controller could allow such users to submit personal information relating to the user's medical condition, history, demographic group, or even DNA data, for example. Other aspects of a user's medical information are possible. The medical information may, in some examples, be aggregated and rendered completely anonymous to facilitate (without breach of privacy or HIPAA laws, for example) medical research, data analysis, and identification of cures of disease or disability. It will be appreciated that vast amounts of medical information and history may be collected to facilitate medical research. In some examples, the repository controller may in turn allow selected recipients, or recipients subscribing to the repository (in this instance parties such as healthcare providers or research institutions), access to the voluntarily submitted medical information.

In some examples, targeted information or other content can be presented via a mobile device. More generally such information may be presented via an “interface”. An interface can exist in many forms. For example, the interface may interact with a user, in a functional or physical way, and may contribute and/or consume content. The interface may be associated with a device, but not necessarily so. The interface may be mouse drive, voice driven, or touch driven, for example. An associated device might be network enabled, but not necessarily so. The device or interface may be associated with local or proximate processing capability. In some examples, a physical interface may be presented by “smart” glasses (for example, Google glasses). In other embodiments, an interface may be intangible, such as a hologram. In further examples, the interface may be may be a non-mobile surface, such as a wall, table top, or side of an appliance. In other examples, an interface may be provided in a kiosk, or by a surface or device inside a motor vehicle, for example.

In some examples, targeted information or other content may be associated with a “location determination” of a user. This term includes detecting a user's presence or location. It may involve active sensing (for example, an accelerometer or other sensor) or a passive identification (for example, RFID). Location identification can be used as trigger to present targeted information or other content in an interface

Targeted information or other content may include “consumable” information or “non-consumable” information (for example, metadata). Consumable examples can be displayed, emailed, pushed, or included in a text message. The information may include tiles, social media, digital data, physical (billboard) embodiments, audio files, commercial art, smart advertisements and so forth.

Viewed broadly, a “device” is any physical object which is capable of being a communication device or can present an interface. The device may be associated with local computational or remote computational functionality.

In some examples, targeted information may include “ad content”. Ad content may include promotional information which characterizes this information from general content. A “promotion” in ad content need not be tied to commerce, or payment, or a transaction, but will usually be associated with receipt of some kind of value. The value could relate to a good or a service (or hybrid of same)

The presentation of the targeted information may seek to extend on-line user “sessions”. In a multi-device world, the conventional definition of a session is becoming increasingly inapplicable. Viewed more broadly, a session in this disclosure includes the idea that the user is trying to achieve a particular task, with that task potentially spread over multiple devices and extended time period. The user could pick up a session on a different device, or after a lapse of time, and so forth. A user could have many parallel sessions going on simultaneously, for example. A session may include user phases, such as a discovery phase, an exploratory phase, a follow-up phase, and so forth. Sessions may be assessed or tied to a success metric, such as a “Bid-Buy-Offer-Watch-Ask seller question” (BBOWA) metric, for example.

The examples discussed above merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

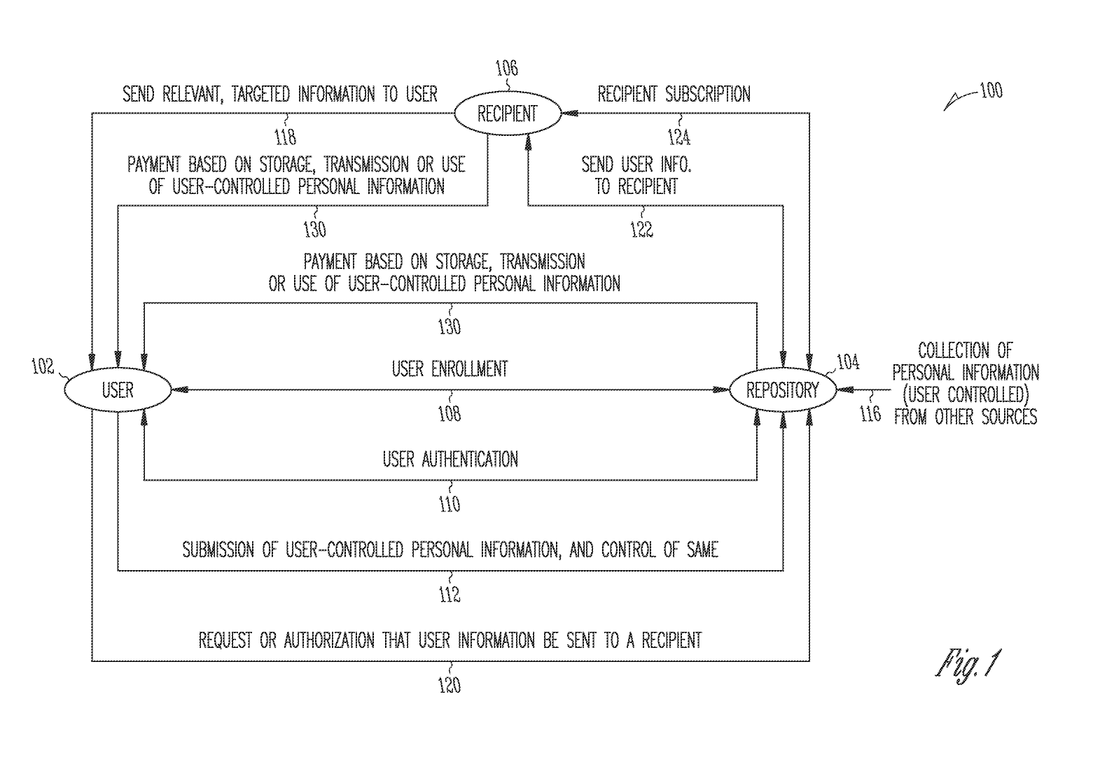

Reference is now made to FIG. 1 of the accompanying drawings. FIG. 1 illustrates the main components of an example embodiment of an identity system, according to the present disclosure. The example system is generally designated by the numeral 190. A user 102 can communicate with a personal data repository 104 that stores user-controlled personal information. The repository may be managed by a controller. The user 102 may communicate with a data repository 104 by enrolling with the repository at operation 108. An enrolled user 102 may subsequently be authenticated at operation 110 when an amendment or supplement to the data stored in the repository is required. In either operation 108 or 110, the user 102 may submit or amend personal information stored in the repository, as shown by operation 112. Generally, the user 102 “owns” and controls his or her “identity” (personal information) in the repository 104 and can control what type of personal information is submitted, which aspects of it, how it is stored, and to what extent it is used or stored, for example. These actions and control are generally designated by the operation 112 in FIG. 1. In some examples, the repository controller can also collect personal data from other sources, such as in operation 116. In some examples, the stored personal data may not be modified or deleted by a user 102 or the repository controller.

The user-controlled personal information can include any of the information discussed above, or any aspect of personal information that the user identifies and wishes to submit and have stored in the data repository 104 for possible communication (by transmission or direct access) to a recipient 106. This communication action is shown at operation 122. A recipient 106 may be any third party having an interest in using the user-controlled personal information (or user-identified aspects of it in the repository to compile relevant, targeted information for the user 102. The presentation or transmission of targeted information to a user is shown at operation 118. As discussed above, recipients 106 may include, without limitation, merchants (ecommerce or traditional), marketing entities, targeted delivery services, or content providers. It will be appreciated that many other recipients 106 are possible.

In some examples, a recipient 106 may subscribe at operation 124 to be granted access to (or be sent) user-controlled profiles or personal data stored in the repository 104.

In some examples, the targeted information sent by a recipient 106 to a user 102 in operation 118 may include relevant notifications or advertisements transmitted at meaningful engagement opportunities (for example, at identified hours or during specific windows of the day when users are typically online after work or at the weekend). The engagement opportunities may be based on user salary payment cycles or other analysis. Many other engagement opportunities for the transmission of targeted information are possible, as well as many types of targeted information itself.

In some example embodiments, the user 102 can select, at operation 120, which recipients 106 should receive the user's 102 personal information, or aspects of this information. The user 102 can select which aspects of information should be further stored in the repository 104, or communicated to one or more recipients 106. The user 102 can limit the use of any or all of the stored personal information. The one or more recipients 106 may, for example, include user-selected recipients, subscribing recipients, or recipients required by law to have certain information sent to them (for example, a tax office). Other types of recipients 106 are possible.

In some embodiments, users 102 are compensated for use of their personal information (for example, at payment operation 130). Compensation may be paid by a recipient 106 using the information, or by the data repository 104 storing it. Compensation may be based on mere submission by a user 102 of the personal data. The prospect of receiving value for submitted personal data may incent users to submit or authorize use of more detailed aspects of their personal information and thus, in turn, improve the relevancy of the targeted information sent to them by a recipient 106.

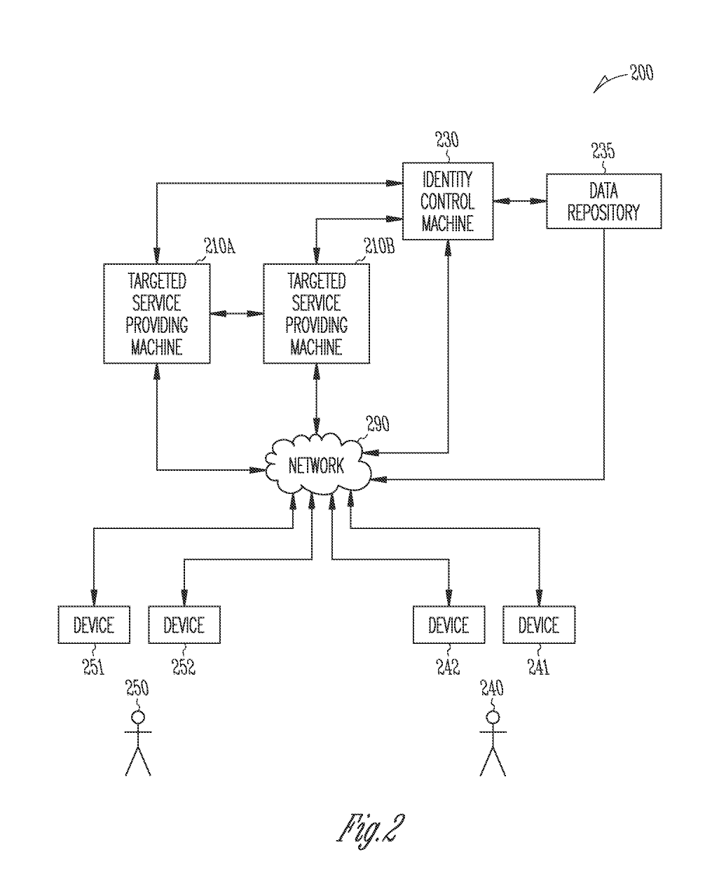

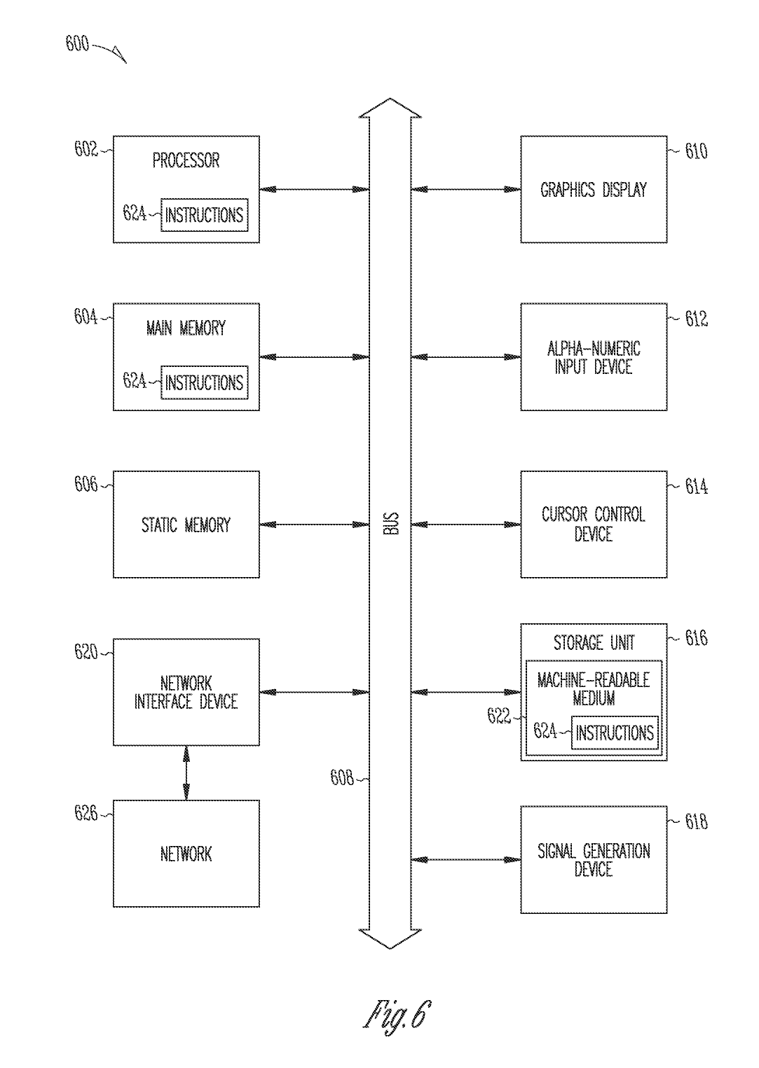

FIG. 2 is a block diagram illustrating an example of a network environment for implementing particular disclosed embodiments. The network environment 200 includes targeted service providing machine 210a (for example, a recipient 106), targeted service providing machine 210b (for example, another recipient 106), identity control machine 230 (described further below), data repository 235, and devices 241, 242, 251, and 252, operated by users 240 and 250, all communicatively coupled to each other via a network 290 to effect any one or more of the operations described herein. The targeted service providing machines 210a and 210b, identity control machine 230, repository 235, and devices 241, 242, 251, and 252 may each be implemented in a computer system, in whole or in part, as described below with respect to FIG. 6.

Any of the machines, repositories, or devices shown in FIG. 1 or FIG. 2 may be implemented in a general-purpose computer which is modified (e.g., configured or programmed) by software to be a special-purpose computer to perform the functions described herein for that machine, database, or device. For example, a computer system able to implement any one or more of the methodologies described herein is discussed below with respect to FIG. 6. Moreover, any two or more of the machines, databases, or devices illustrated in FIG. 1 or FIG. 2 may be combined into a single machine, and the functions described herein for any single machine, database, or device may be subdivided among multiple machines, databases, or devices.

As used herein, a “repository” is a data storage resource and may store data structured as a text file, a table, a spreadsheet, a relational database (e.g., an object-relational database), a triple store, a hierarchical data store, or any suitable combination thereof. The network 290 may be any network that enables communication between or among machines, databases, and devices (e.g., the targeted service providing machines 210 and the data repository 235). Accordingly, the network 290 may be a wired network, a wireless network (e.g., a mobile or cellular network), or any suitable combination thereof. The network 290 may include one or more portions that constitute a private network, a public network (e.g., the Internet), or any suitable combination thereof.

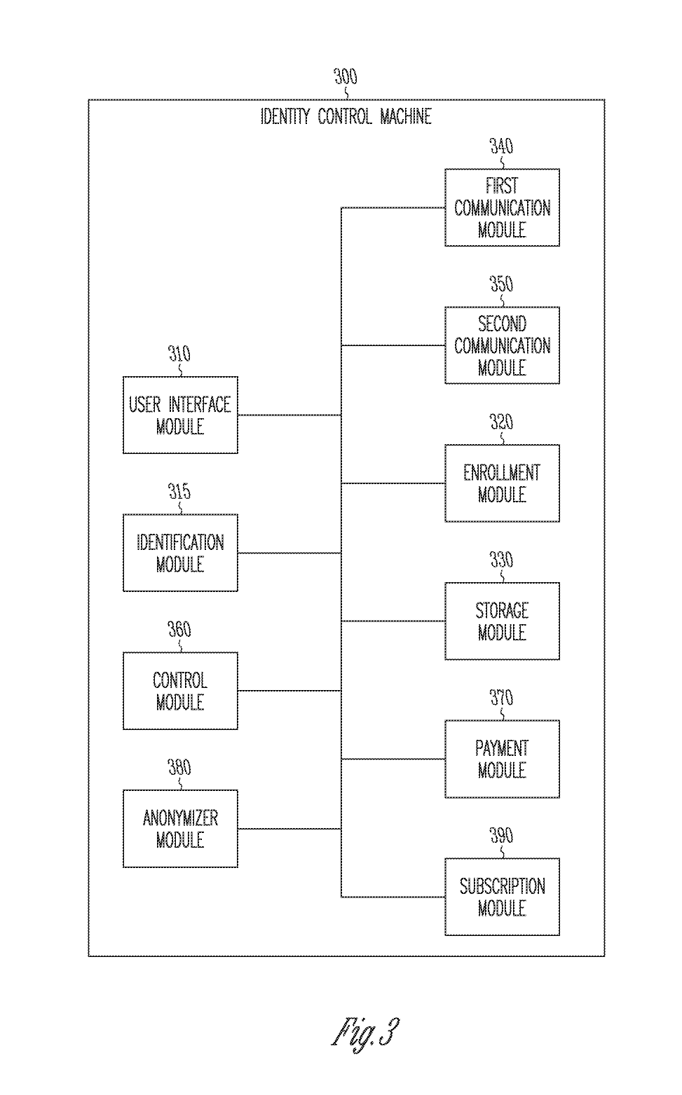

FIG. 3 is a block diagram illustrating components of an identity system for implementing particular disclosed embodiments. The identity system may include an identity control machine, shown generally at 300 (230 in FIG. 2), and may be associated with the repository 104 (FIG. 1), 235 (FIG. 2) or otherwise form part of the network 290 (FIG. 2). The identity control machine 300 is shown as including a user interface module 310, an identification module 315, an enrollment module 320, a storage module 330, a first communication module 340, a second communication module 350, a control module 360, a payment module 370, an anonymizer module 380, and a subscription module 390 all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The user interface module 310 may be configured to provide a user interface to a user connecting to the identity control machine 300. For example, the identity control machine 300 may serve a web page or mobile application. The user may respond to the user interface by enrolling, or logging in (or other authentication), e.g., with a user name and password. The login information provided by the user may be stored by the storage module 330 and used by the identification module 315 to identify the user. The storage module 330 may also be operated by a repository controller (see above) to store user-controlled personal data in the repository (FIG. 1 and FIG. 2). The enrollment module 320 is configured to enroll users with the data repository. The first communication module 340 is configured to receive an enrolled user authentication (log in) and personal data relating to the user (102 in FIG. 1). The control module 360 is configured to allow an authenticated user (102 in FIG. 1) to supplement or modify the received personal data and to select recipients (106 in FIG. 1) of user-identified aspects of the received personal data. The second communication module 350 is configured to communicate the user-identified aspects to a selected recipient. The payment module 370 is configured to convey a value to the user based on the communication to, or use by, the selected recipient of the user-identified aspects of the personal data. The anonymizer module 380 is configured to associate an opaque identifier with the user-identified aspects of the personal data. The subscription module 390 is configured to allow a third party to register with the data repository as a potential recipient of the user-identified aspects of the personal data,

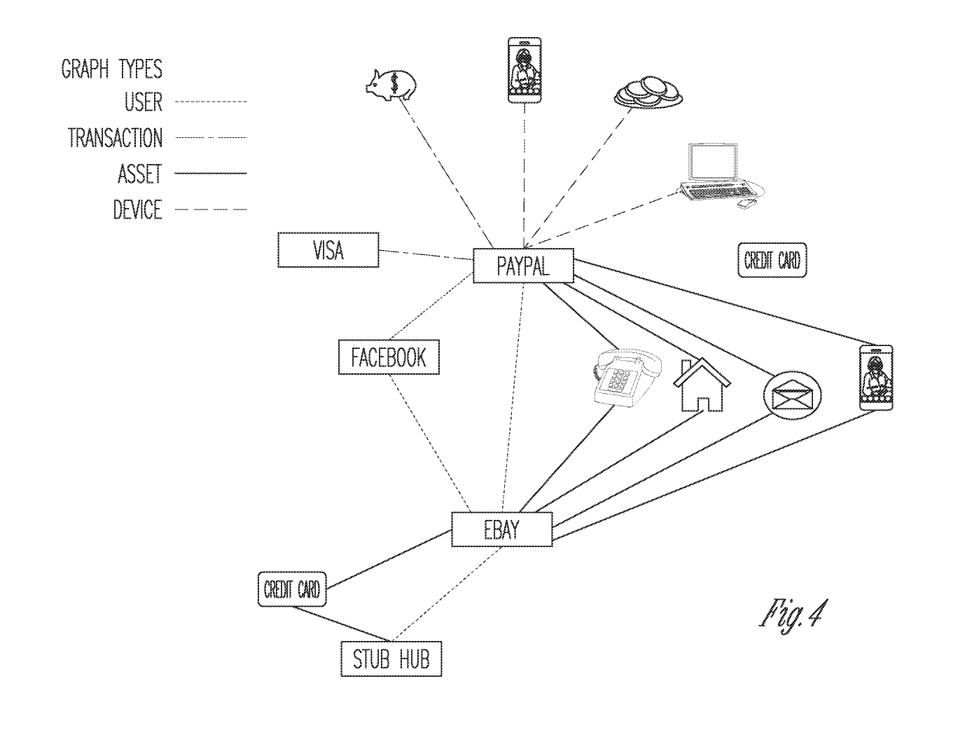

FIG. 4 is a block diagram illustrating data relationships in particular disclosed embodiments. The web of relationships 400 may be used to establish a single user-controlled identity for a user based on multiple relationships between the user and various services. For example, device relationships are shown between PayPal and each of a mobile device, a cookie (stored on a device), and a computer. When a single account is accessed from multiple devices, each of those devices may be associated with the user and stored as user-controlled personal information in the repository 104 (FIG. 1). Also shown are transaction relationships between PayPal and each of a savings account and a Visa card. The transaction relationships may also be stored as user-controlled personal information in the repository 104 (FIG. 1).

Any of the machines, repositories, or devices described above may be used or configured partially or entirely as appropriate to perform one or more of the methods, operations, or functions described herein, or as set forth below in the following method steps. Other devices or systems may be employed. Some examples of the present disclosure include methods for use in user-controlled identity systems.

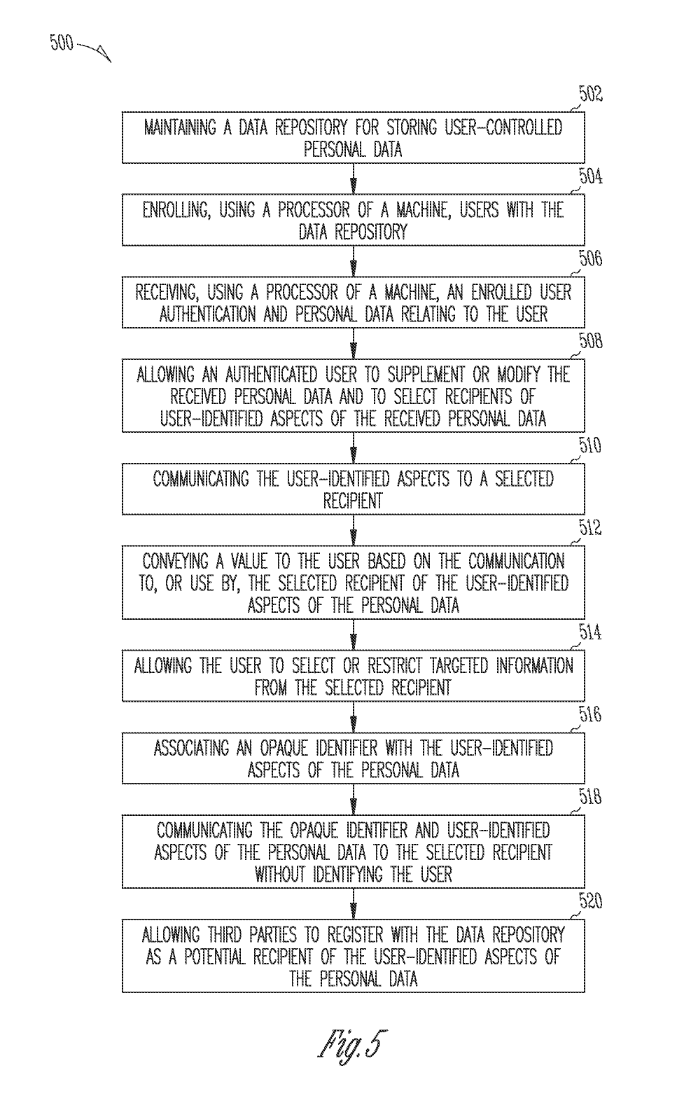

One such method is illustrated in FIG. 5. In this example embodiment, a method 500 includes: at block 502, maintaining a data repository for storing user-controlled personal data; at block 504, enrolling, using a processor of a machine, users with the data repository; at block 506, receiving, using a processor of a machine, an enrolled user authentication and personal data relating to the user; at block 508, allowing an authenticated user to supplement or modify the received personal data and to select recipients of user-identified aspects of the received personal data; and, at block 510, communicating the user-identified aspects to a selected recipient.

In some embodiments, the method 500 further includes, at block 512, conveying a value to the user based on the communication to, or use by, the selected recipient of the user-identified aspects of the personal data. The method 500 may further include, at block 514, allowing the user to select or restrict targeted information from the selected recipient. Still further, the method 500 may further include, at block 516, associating an opaque identifier with the user-identified aspects of the personal data.

In some embodiments, the method 500 includes, at block 518, communicating the opaque identifier and user-identified aspects of the personal data to the selected recipient without identifying the user, and may further comprise, at block 520, allowing third parties to register with the data repository as a potential recipient of the user-identified aspects of the personal data.

FIG. 6 is a block diagram illustrating components of a machine 600, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 6 shows a diagrammatic representation of the machine 600 in the example form of a computer system and within which instructions 624 (e.g., software, a program, an application, an applet, app, or other executable code) for causing the machine 600 to perform any one or more of the methodologies discussed herein may be executed, in whole or in part. In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a distributed (e.g., peer-to-peer) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform all or part of any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC) or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which are stored the instructions 624 embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 (e.g., network 290) via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. An identity system, comprising:
a data repository for storing user-controlled personal data;
an enrollment module to enroll users with the data repository;
a first communication module to receive an enrolled user authentication and personal data relating to the user;
a control module allowing an authenticated user to supplement or modify the received personal data and to select recipients of user-identified aspects of the received personal data; and
a second communication module to communicate the user-identified aspects to a selected recipient.

2. The identity system of claim 1, further comprising:
a payment module to convey a value to the user based on the communication to, or use by, the selected recipient of the user-identified aspects of the personal data.

3. The identity system of claim 1, wherein the control module is further to allow the user to select or restrict targeted information from the selected recipient.

4. The identity system of claim 1, further comprising an anonymizer module to associate an opaque identifier with the user-identified aspects of the personal data.

5. The identity system of claim 4, wherein the second communication module is to communicate the opaque identifier and user-identified aspects of the personal data to the selected recipient without identifying the user.

6. The identity system of claim 1, further comprising:
a subscription module for allowing a third party to register with the data repository as a potential recipient of the user-identified aspects of the personal data.

7. A method comprising:
maintaining a data repository for storing user-controlled personal data;
enrolling, using a processor of a machine, users with the data repository;
receiving, using a processor of a machine, an enrolled user authentication and personal data relating to the user;
allowing an authenticated user to supplement or modify the received personal data and to select recipients of user-identified aspects of the received personal data; and
communicating the user-identified aspects to a selected recipient.

8. The method of claim 7, further including conveying a value to the user based on the communication to, or use by, the selected recipient of the user-identified aspects of the personal data.

9. The method of claim 7, further including allowing the user to select or restrict targeted information from the selected recipient.

10. The method of claim 7, further comprising associating an opaque identifier with the user-identified aspects of the personal data.

11. The method of claim 10, further including communicating the opaque identifier and user-identified aspects of the personal data to the selected recipient without identifying the user.

12. The method of claim 7, further including allowing third parties to register with the data repository as a potential recipient of the user-identified aspects of the personal data.

13. A non-transitory machine-readable storage medium comprising instructions that, when executed by one or more processors of a machine, cause the machine to perform operations including:
maintaining a data repository for storing user-controlled personal data;
enrolling, using a processor of a machine, users with the data repository;
receiving, using a processor of a machine, an enrolled user authentication and personal data relating to the user;
allowing an authenticated user to supplement or modify the received personal data and to select recipients of user-identified aspects of the received personal data; and
communicating the user-identified aspects to a selected recipient.

14. The non-transitory machine-readable storage medium of claim 13, wherein the operations further comprise any one or more of the operations defined in claims 8-12.
